(19) United States
(12) Patent Application Publication
(10) Pub. No.: US 2022/0033196 A1
(43) Pub. Date: Feb. 3, 2022

(54) PROCESSING TOOL AND GUIDE ELEMENT FOR TRANSFERRING A COMPONENT FROM A PICK-UP POSITION TO A PROCESSING POSITION

(71) Applicant: Richard Bergner Holding GmbH & Co. KG, Schwabach (DE)

(72) Inventors: Klaus DEHLKE, Windsbach (DE); Markus VOH, Schwabach (DE)

(73) Assignee: Richard Bergner Holding GmbH & Co. KG, Schwabach (DE)

(21) Appl. No.: 17/391,779

(22) Filed: Aug. 2, 2021

(30) Foreign Application Priority Data
Aug. 3, 2020 (DE) 10 2020 209 745.3

(51) Int. Cl. B65G 47/90

(52) U.S. Cl. CPC B65G 47/90

(57) ABSTRACT

A processing tool used to transfer a component, in particular a joining element, from a pick-up position to a processing position. For process-reliable guidance, a guide element held in a hold-down-device is arranged, through which the component is pressed during operation and which exerts an elastic holding force. The guide element has a sleeve, in particular a metallic sleeve, which has a guide structure made of an elastomer. The guide structure is formed in particular by an elastomer ring or by several axial guide strips.

This nonprovisional application claims priority under 35 U.S.C. § 119(a) to German Patent Application No. 10 2020 209 745.3, which was filed in Germany on Aug. 3, 2020, and which is herein incorporated by reference.

### BACKGROUND OF THE INVENTION

### Field of the Invention

The present invention relates to a processing tool for transferring a component from a pick-up position to a processing position, in particular for pressing a press-fit element into a workpiece. The invention further relates to a guide element for such a processing tool.

### Description of the Background Art

A processing tool can be found, for example, in DE 10 2008 033 933 A1, which corresponds to US 2009/0279991, which is incorporated herein by reference.

When inserting components in workpieces, especially sheet metal, it is regularly necessary to guide the components precisely during the process.

Particularly in the case of processing tools and processes in which the component is introduced in a form-fitting and/or force-fitting manner with the aid of a forming process, a defined insertion of the component into the workpiece is required for a high-quality connection between the component and the workpiece. This applies in particular to those processes in which the components are inserted into the workpiece with the aid of a press-fit tool. The components in this case are in particular punching or press-fit elements which are themselves shaped during their press-fitting and/or which shape the workpiece during their press-fitting. During the press-fit process, these components are often pressed against a die as a counterholding element. The forming process requires the component to be aligned and guided as accurately as possible in relation to this die.

In this context, the term “components” can refer to press-fit elements, especially press-fit nuts, i.e. joining elements which are inserted by pressing into a pre-punched sheet and which have a threaded hole with a thread for fastening a screw. The same applies to punch nuts, which are introduced into a non-pre-punched sheet by a punching process. In addition to the nuts, so-called press-fit bolts or other joining elements may also be provided. The press-fit bolts usually have a bolt head and often, when designed as a screw, an external thread.

Nowadays, these components are automatically fed to the processing tool, especially in the automotive industry. During processing, the components are typically fed individually from a magazine or stock to the processing tool into a pick-up position. From this pick-up position, the component is brought into a processing position before the actual setting process takes place, in which the component is inserted into the sheet metal. In the processing position, for example, the component rests against the sheet metal and/or the die before the setting and/or forming process begins. Both the transfer from the pick-up position to the processing position and the actual pressing-in operation are typically performed with the aid of a press-in punch. For precise guidance of the components, grippers can be provided, for example, which clamp the joining element (component) in the pick-up position.

During the process, the processing tool usually moves against the workpiece and presses it against a support (die) with the joining element or with the aid of a so-called hold-down device. The component itself is guided through the hold-down device from the pick-up position to the processing position.

DE 10 2008 033 933 A1 provides a slotted guide sleeve made of an elastic material arranged in the hold-down device for reliable guidance of the component from the pick-up position to the processing position. Individual spring tabs of the slotted guide sleeve exert an elastic holding force on the component while the component is pushed through the guide sleeve.

In automated systems, such as those used in production plants, where the press-fit elements are pressed in fully automatically, a process-safe design is crucial. In particular, the guide elements must be as wear-resistant as possible and at the same time elastic.

This is achieved in DE 10 2008 033 933 A1 by using a high-quality spring steel for the slotted sleeve. However, the manufacture of such a guide sleeve is complex and expensive.

### SUMMARY OF THE INVENTION

It is therefore an object of the present invention to ensure a process-reliable guidance of such a component from a pick-up position to a processing position in a processing tool by using a wear-resistant, inexpensive and easy-to-manufacture guide sleeve.

The object is achieved according to the invention by a processing tool for transferring a component from the pick-up position to the processing position. The processing tool is in particular an automated tool which is provided for (fully) automatic pressing-in of the components, which are preferably designed as press-fit elements. The processing tool has a punch which transfers the component from the pick-up position to the processing position. The processing tool preferably also has a hold-down device arranged at the end and extending in an axial direction. During operation the hold-down device is pressed against a surface of a workpiece. Furthermore, a sleeve-shaped guide element is provided, which is preferably a part of the hold-down device or is preferably arranged as an additional element within the hold-down device. During a respective setting process, the component is guided through the guide element from the pick-up position to the processing position. The guide element is designed in such a way that it exerts an elastic holding force on the component at least over a partial area. For this purpose, the guide element has an elastic guide structure. The guide element, in particular the guide structure, is designed in such a way that during the processing operation the punch presses the component through the guide element, in particular through the guide structure, against the elastic holding force. The guide element has a sleeve in which the elastomer guide structure is arranged and fastened. The sleeve is more rigid than the guide structure and is, for example, a metal or steel sleeve. The elastomer is, for example, a thermoplastic elastomer (TPE) or a rubber.

The component is in particular a press-fit joining element, such as a punch nut or a press-fit nut or also a press-fit bolt. In the following, reference is made to a joining element as the component without limitation of the generality.

The guidance of the component, i.e. the joining element, and the exertion of an elastic retaining force on the joining element is carried out in a simple manner with the aid of the elastic guide structure. In one embodiment, the length of the guide structure made of the elastic material is typically greater than the length of the component in the axial direction, i.e. in the joining direction in which the component is pressed through the guide element and thus also through the hold-down device into the processing position. If the component is a bolt, the length of the guide structure is greater than the length of a head of the bolt. A bolt usually has a shank provided with an external thread, for example, and a widened head with which the bolt rests on one side of the workpiece in the set state.

At the same time, the guide structure defines a (minimum) inner dimension, specifically an inner diameter, which is smaller than a (maximum) outer dimension of the component, so that the component is held and guided by the elastic force exerted by the guide structure.

The guide structure can be designed in such a way that it abuts over its entire length against an inner wall of the sleeve directly, or indirectly with the interposition of a further component, for example an assembly sleeve. In particular, the guide structure is firmly bonded to the sleeve and/or fastened by friction and/or positive locking to the sleeve. For firmly bonding, the guide structure is glued or vulcanized to the sleeve or to the additional component. In particular, the guide structure does not have any areas that can pivot or bend. Specifically, no such areas that deflect radially when the component is pressed through during the pressing process. Rather, the elastic guide structure is preferably merely compressed in the radial direction.

The guide structure can be designed as a tube or hose, for example, which is unslotted. The tube preferably has a constant cross-sectional geometry over its entire length, in particular a hollow cylindrical geometry. Such an elastic tube is characterized by a simple and thus inexpensive design. It can be manufactured inexpensively, for example from a semi-finished product such as a hose, and then only needs to be cut to a desired length.

Fastening the elastomer to the sleeve, in particular the metal sleeve, involves assembly work. In order to keep this to a minimum and at the same time achieve reliable and permanently process-reliable fastening of the guide structure, it is provided in an expedient embodiment that the guide structure has a number of strip-shaped elements, i.e. has one or more strip-shaped elements and is formed in particular by this number of strip-shaped elements. According to a first variant, several of such strip-shaped elements extend in the axial direction in the manner of guide strips. According to a second variant, at least one such strip-shaped element extends in the manner of a ring in a circumferential direction. In the case of the strip-shaped embodiment, preferably a plurality of such strips is arranged distributed around the circumference. In the case of an annular embodiment, preferably only a single annular element is provided. In this case, the annular element is optionally designed as a closed ring and, in particular, as a slotted ring, which is thus not completely closed. Furthermore, in one variant it is provided that several ring segments are arranged in the circumferential direction and thus at the same axial height. These ring segments are in particular equally distributed around the circumference. Each of these ring segments thus forms a strip-shaped element.

Also one or more grooves, i.e. in particular either longitudinal grooves or an annular groove, can be formed on the inner wall, which are designed to receive the guide strips or the ring-shaped element. In the design with individual ring segments, one annular groove is provided in which the ring segments are distributed, or individual recesses are formed distributed around the circumference, in each of which a ring segment is inserted.

The guide structure can be applied to a mounting sleeve which is inserted between the guide structure and the sleeve and which is made in particular of plastic. The mounting sleeve generally has a higher hardness than the guide structure and preferably at the same time a lower hardness than the sleeve. The guide structure is fastened indirectly to the sleeve via the mounting sleeve.

The mounting sleeve can be designed, for example, as a tube with an annular cross-section and has, for example, a continuous wall. Alternatively, the mounting sleeve is provided with one or more slots in the axial direction and is therefore slotted. The inner wall of the mounting sleeve is preferably cylindrical, and the guide structure rests against this cylindrical surface. Alternatively, the mounting sleeve has one or more grooves, i.e. longitudinal grooves or an annular groove, in which the strip-shaped elements are inserted.

The particular advantage of this mounting sleeve is that it can be formed as a mounting unit together with the guide structure fixed therein and can be provided as a wear and replacement part. In the event of wear due to operation, it is therefore possible to replace this mounting unit in a simple manner.

The mounting sleeve can be press-fitted into the sleeve, i.e. it is a press-fit sleeve. The mounting sleeve therefore has an outer diameter which is somewhat oversized compared to an inner diameter of the sleeve.

The sleeve or the assembly sleeve can have at least one shoulder at the end on which the guide strips are supported. This measure therefore creates a form fit that is effective in the axial direction. This reliably absorbs the forces occurring in the axial direction when the joining element is pressed through.

In the design with the guide strips, only 3-6 and, for example, only 3 or 4 guide strips can be provided. Furthermore, the guide strips can extend only over a small angular range of, for example, 5°-20°, in particular only in the range of 5°-10°.

Preferably, the guide strips are rectangular, oval or circular in cross-section. They can therefore be manufactured in a simple manner. Since in the preferred embodiment they only extend over a small angular range, they are preferably not formed—viewed in cross section—as a circular ring segment, i.e. their inside and outside are not formed by concentric circles or circular segments.

As an alternative to the guide strips, the guide structure can be designed as a tube, which is in particular in the form of a hollow cylinder with concentric inner and outer walls. In a preferred embodiment, the tube extends only over a small length in the axial direction, for example only over a maximum of 10%, 25% or ⅓ of the length of the sleeve, so that the tube is designed as a ring. The length of the ring in the axial direction is, for example, in the range of the axial length of the component, for example in the range of 0.5 to 4 times, in particular in the range of 1 to 2 times, the axial length of the component. This is the axial length of the nut in the case of a nut and the axial length of a head in the case of a bolt with a head.

As an alternative to this annular element extending over only a short axial length, the tube extends over a major portion of the length of the sleeve, for example over more than 75% and preferably over the entire length of the sleeve.

The guide structure in the form of an (elongated) tube or ring can be slotted in the axial direction. One or more slots distributed around the circumference can be arranged. In the case of an elongated tube, a circumferential, continuous wall is preferably formed in an upper or lower region, so that the tube is formed in one piece overall. As an alternative to the slotted variant, an unslotted, cylindrical variant is provided.

The tube can have several tube segments or ring segments separated from one another in the circumferential direction. In this case, it is in particular a matter of individual parts that do not hang together. For example, a total of 2-5 and in particular 2 or 3 such tube segments are provided. The segmentation simplifies assembly. This embodiment with the multiple tube segments applies in the same way to the annular element. The individual tube segments are each formed as circular ring segments when viewed in cross-section. The separating slot between the individual segments in each case covers preferably only a small angular range, so that, for example, the tube segments cover a total of at least 300° in the circumferential direction.

The tube and thus generally the guide structure can extend only over an axial subregion of the sleeve and is preferably annular in shape. In particular, the guide structure is designed as a slotted or segmented ring or also as a closed ring. In the case of a segmented ring, the ring is formed by a plurality of ring segments which are spaced apart from one another in the circumferential direction.

The ring can be located in an annular groove, which is preferably formed in a lower section of the sleeve. The annular groove is preferably formed directly on the inner wall of the sleeve or alternatively also on the mounting sleeve. Alternatively or additionally, the ring and in particular also the annular groove is preferably formed in the lower third or lower quarter of the sleeve or mounting sleeve.

Especially in the embodiment with the guide strips but also in the embodiment of the guide structure as a tube, the guide structure can extend at least over a major part of the length of the sleeve, especially for example over at least ¾ of the length of the sleeve. The guide structure can extend along the entire length of the sleeve. Preferably, it generally begins at the upper edge of the sleeve.

Also, the guide structure, especially in the annular example, can extend only over a short area of the length of the sleeve and has, for example, only a length smaller than ⅓ or ¼ of the length of the sleeve. The embodiment with the annular guide structure is also formed by the previously described embodiment with the at least one strip-shaped element in the circumferential direction.

In this case, the guide structure can be arranged in the lower half of the sleeve, in particular in the lower third.

A shoulder can be formed against which the guide structure rests. According to a first embodiment, this shoulder is designed as a simple step. In particular, the shoulder is introduced directly into the inner wall of the sleeve or alternatively into the inner wall of the assembly sleeve. In the area of the shoulder, therefore, there is a widening or also a reduction of the inner dimension, in particular of the inner diameter of the sleeve (mounting sleeve). According to an example, the shoulder is inserted from below against the axial direction, so that the guide structure can therefore be inserted from below. This permits simple assembly.

The reverse variant is the preferred variant, according to which the shoulder or step is formed in the axial direction, so that there is a reduction in the inside diameter in the axial direction and the guide structure is in positive contact with the step in the axial direction. When the component is pressed through the guide structure, the axial forces are therefore also absorbed via the step.

To ensure good insertion of the component into the guide structure, the latter can have an insertion chamfer at its upper end oriented counter to the axial direction. In the case of the several guide strips arranged distributed around the circumference, each guide strip has such an insertion chamfer.

A sensor can be arranged in the area of the sleeve, in particular in the wall of the sleeve, and is designed to detect a component located in the sleeve. The sensor is preferably arranged in a lower half, in particular a lower third of the sleeve, or is designed to detect a component located in the lower half or lower third.

The arrangement of the sensor in the area of the sleeve can be combined in particular with the design of the guide structure in the form of a ring, with the ring in particular lying in an annular groove in the lower part of the sleeve. In this embodiment, the sensor is positioned above the ring, preferably directly above it. In this way, the sensor detects whether the component intended for the setting process is in contact with the ring during operation, so that it can then be pressed into the sheet from this position. The sensor therefore ensures that the component is in the desired position before the press-fit process and has not, for example, jammed further up in the sleeve. In particular, the setting process is only carried out when the sensor detects a component.

The material used for the guide structure can be a wear-resistant, elastic material. the guide structure preferably is formed entirely or substantially of this material. In a useful embodiment, the elastic guide structure is made of a polyurethane elastomer. Investigations have shown that polyurethane elastomers have a high wear resistance and can withstand the desired requirements.

The guide structure can be made of an NDI-based polyurethane elastomer. Specifically, this is a cast elastomer. By “NDI-based polyurethane elastomer” is meant a rubber-elastic polyurethane material which is produced on the basis of NDI (naphthylene-1,5-diisocyanate). Thus, NDI-based polyurethane is understood to mean a polyurethane prepared by a polyaddition reaction of naphthylene diisocyanate (NDI) with polyphones. An example of such a rubber-elastic polyurethane material is the material marketed under the brand name “Vulkollan”.

The material of the guide structure can have a cellular structure in the manner of a foamed material. A cellular structure is generally understood to mean a material in which individual cells are separated from one another by cell walls. The cells have, for example, an internal diameter in the range from 0.1 mm to 3 mm. The advantage of the cellular structure is its good compressibility and good elasticity. It is therefore particularly suitable for applying the desired holding force to the component when it passes through the blank holder.

The material of the guide structure and thus the guide structure itself preferably has a density in the range of 250-400 kg/m³. When using a cellular material, the specified density is the so-called bulk density or also the so-called volume weight, i.e. the density based on the volume including the cells. Through the appropriate choice of density, the desired holding force can be set appropriately.

Overall, the guide structure in the examples, especially in the example with the guide strips or the ring-shaped structure, is characterized by its very simple geometry and also simple manufacturability. Specifically, when the guide structure is used, there are no elastic finger or spring elements that apply an elastic force to the joining element. Rather, the elastic holding force is preferably exerted exclusively by compressing the material of the elastic guide structure. The guide structure usually has an inner diameter that is at least somewhat smaller than an outer dimension of the joining element. When the component is pushed through the guide element, the material of the guide structure is therefore compressed in the radial direction, i.e. perpendicular to the axial direction, at the respective position where the component is currently located.

Elastic material can therefore be understood here to mean, in particular, elastic compressibility. In particular, the retention force is exerted exclusively by compression. This means that radial expansion of the guide structure preferably does not occur. That is to say that a radial expansion of its outer wall, so that an outer dimension of the guide structure would be increased at the current position of the joining element, preferably does not occur.

The material also has a sufficient restoring force and a short relaxation time so that it returns to its original shape after the component has passed through, i.e. the guide structure resumes its original wall thickness immediately after the component has passed through. Immediately is understood to mean a time in the range of 1 to 2 seconds at the most. This is necessary to achieve the desired high cycle rates during automatic joining and setting of the joining elements.

The guide structure expediently has a general length, an inner dimension, in particular an inner diameter, and a wall thickness. In particular, the wall thickness is constant over the entire length. Preferably, the inner diameter is also constant over the entire length. Preferably, the wall thickness is constant in the circumferential direction of the tube. Alternatively, the wall thickness varies in the circumferential direction. In this case, the wall thickness is defined by the thickest region (viewed in the circumferential direction) of the wall.

The length of the tube and the guide element is typically several centimeters, for example 2 to 8 cm, and is usually significantly greater than the length of the joining element to be set (viewed in the axial direction in each case). The length of the tube is in particular more than twice or even more than five times as long as the length of the joining element, or of the head in the case of a bolt.

The wall thickness is preferably in the range of 2 to 10 mm and in particular in the range of 2 to 3 mm. Particularly in conjunction with the cellular structure, sufficient compressibility is achieved to generate the desired holding force.

Preferably, the outer dimension of the joining element is 0.5 mm to 2 mm, and in particular 0.8 mm to 1.2 mm, larger than the inner dimension of the guide structure. In each case, the outer dimension is understood to be a maximum outer dimension of the component and the inner dimension is understood to be a minimum dimension (distance) of the inner space of the guide structure. In the case of circular geometries, this is the diameter in each case. In the variant with guide strips, these define an inner circle with their inner sides. The diameter of this circle forms the inner dimension. The dimensions are always viewed in a sectional plane perpendicular to the axial direction. If the outer or inner dimension varies in the axial direction, the specified dimension refers to the largest outer dimension of the component viewed in the axial direction or to the minimum inner dimension of the guide structure.

In an example—especially in the tube variant—the guide structure—viewed in cross section to the axial direction—has an inner contour that deviates from the circular shape. This is, for example, corrugated, polygonal and in particular trilobular. As a result, the component preferably does not lie against the inner wall of the tube over its entire circumference, but at least the wall of the tube is compressed differently by the profiled structure when viewed over the circumference, i.e. protruding areas are compressed more strongly.

Preferably, the punch can have the same external dimension and preferably also the same cross-sectional geometry as a head area of the component against which the punch moves. This ensures that the punch rests on the component over as large an area as possible.

The guide structure can be expanded at its upper end so that it forms an approximately conical insertion chamfer for the joining element. Over its remaining length, the guide structure, which is designed in particular as a tube, preferably has a constant inside diameter. In this case, therefore, the inside diameter in this region increases somewhat toward the end. However, this expanded end region amounts to a maximum of 25% or a maximum of 15% of the total length of the tube used.

The guide structure can be conveniently fastened to the inner wall of the sleeve or the mounting sleeve. This is done by adhesive bonding, for example, or alternatively directly during the formation of the guide structure, for example during a casting process. Alternatively, the material connection is made by vulcanization. The guide structure and the sleeve/mounting sleeve thus form a permanently joined unit which cannot be separated without causing damage, for example. This connection reliably holds the guide structure in the sleeve, even when the punch is withdrawn after a press-fit process.

Furthermore, the sleeve can have an upper retaining collar which is formed at the end of the sleeve. This retaining collar is designed in particular in the form of an annular washer and is oriented perpendicular to the axial direction. It points outward so that, viewed in cross section, the sleeve with the guide structure located therein is approximately T-shaped. The collar serves, for example, as an assembly aid and is used, for example, to fasten the assembly unit formed of a sleeve and guide structure. The guide structure itself preferably does not have a collar. Alternatively, the guide structure itself may also have a collar.

The assembly unit formed of the sleeve and the guide structure (and where applicable the mounting sleeve) forms the guide element, which is inserted in the blank holder, in particular with a precise fit. In this embodiment, therefore, a coaxial, concentric arrangement of the assembly unit with the hold-down device is provided. The retaining collar serves in particular to rest on an upper side of the hold-down device and is clamped, for example, between the hold-down device and a counter-bearing plate. In particular, the structural unit allows easy replacement, for example in the event of wear of the guide structure.

The guide structure can be located directly in the hold-down device or indirectly via the mounting sleeve. In this respect, the hold-down device forms the sleeve.

The object is achieved according to the invention further by a guide element for such a processing tool described above, wherein the guide element comprises a sleeve, in particular a metal sleeve with a guide structure made of an elastomer mounted therein.

The guide element is overall a replacement and wear part which is used as a replacement part in the processing tool described above. The advantages and preferred embodiments mentioned above with regard to the processing tool are to be applied mutatis mutandis to the claimed guide element.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein: Examples of embodiments of the invention are explained in more detail below with reference to the figures. These show in partially simplified representations:

FIG. 1 is a partial cross-sectional view of a processing tool with a guide element, which has an elastic guide structure located in a sleeve,

FIG. 2 is a partial cross-sectional view of a processing tool in which the elastic guide structure is fixed directly in a hold-down device,

FIG. 3 is a cross-sectional view of the guide structure according to a first embodiment,

FIG. 4 is a cross-sectional view of the guide structure according to a second embodiment

FIGS. 5A-5E show half sections of various embodiments in which the guide structure is formed as a ring,

FIGS. 6A-6C are views of different variants of the guide structures in a tubular or annular configuration,

FIGS. 7A-7B are views from below of an exit side of the sleeve with inserted guide structure according to FIGS. 5A, 5B and FIGS. 5C, 5D,

FIGS. 8A-8D are semi-sections of various embodiments in which the guide structure is formed by a plurality of axial guide strips and in which the guide strips extend along a majority of the axial length of the sleeve,

FIG. 9A-9C show top views of an entry side of the sleeve with inserted guide structure according to FIGS. 8A-8C,

FIGS. 10A-10E show semi-sections of various embodiments in which the guide structure is formed by a plurality of axial guide strips and in which the guide strips extend over a short length in a lower region of the sleeve only, and

FIG. 11 is half section of a sleeve with a ring as a guide structure and with a sensor.

### DETAILED DESCRIPTION

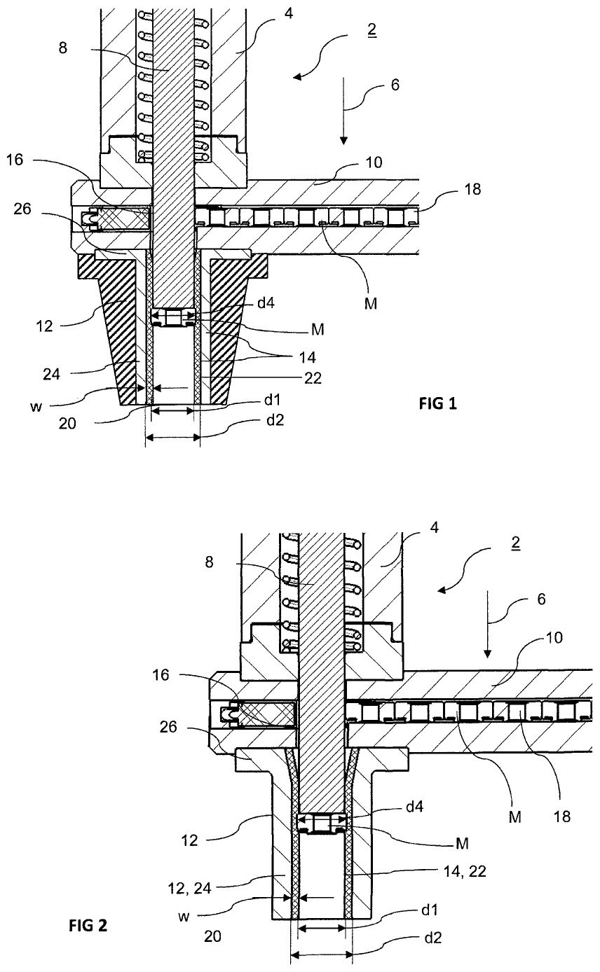

The processing tools shown in detail in FIGS. 1,2 are designed as press-fit tools 2 and are used for pressing components M, namely in particular press-fit nuts or also press-fit bolts shown in the figures, into a workpiece not shown in more detail here, which is for example a sheet with or without premanufactured holes.

The press-fit tool 2 comprises a punch 8 movable in a cylinder 4 in the press-fit or axial direction 6, which is held in its upper starting position by spring force in the shown embodiment. The cylinder 4 is attached to a preferably plate-shaped feed unit 10. A holding-down device 12 with a guide element 14 inserted therein is attached to the underside of the feeding unit.

The components M to be pressed are fed individually to the press-fit tool 2 from a storage container via the feed unit 10 into a pick-up position 16. In the example, the feed unit 10 comprises a feed channel 18 in which the components M are lined up and then pushed one by one into the pick-up position 16. In this position, the respective component M is located within a channel in which it is then displaced by the punch 8 in the axial direction 6 during the setting process. In this pick-up position 16, the component M is preferably held in a spring-loaded manner by a holding device, for example by means of holding claws. This holding device comprises, for example, at least one elastically mounted latch or gripper arm. The latch arm is preferably mounted to pivot against a spring force for this purpose. The latch arm has a special contour with which the component M is gripped at least in partial areas, so that a play-free positioning of the component M in the pick-up position 16 is ensured.

In the illustrated embodiment, the feed unit 10 is arranged laterally and the feed channel 18 extends perpendicular to the axial direction 6 for lateral feeding of the press nuts M.

During the setting or machining process, the entire press-fit tool 2 is moved against the sheet metal in the axial direction 6 so that the blank holder 12 presses the sheet metal against a support, in particular a die. For pressing the nut M into the sheet metal, the punch 8 is moved in a positively driven controlled manner in the axial direction 6, for example hydraulically, pneumatically or also electrically. Here, the punch 8 presses the press nut M out of the pick-up position 16 and through the guide element 14 until the component M reaches the actual processing position 20 at the end of the hold-down 12. The processing position 20 is therefore defined by the end of the hold-down 12 and corresponds to the position at which the component M comes to rest on the workpiece before the actual press-fit process starts. For the subsequent press-in operation, the punch 8 exerts a defined press-in force on the component M, which usually leads to a deformation of the component M and/or the sheet metal.

The press-fit tool 2 is part of an automated device so that the successive press-fitting of a large number of components M takes place automatically. For this purpose, the individual components are automatically fed to the press-fit tool 2, which is automatically actuated with the aid of a control device and, if necessary, moved to a defined position for inserting the component into the sheet.

When the component M is transferred from the pick-up position 16 to the processing position 20, it is pressed through the guide element 14.

The guide element 14 generally includes a guide structure 22 made of an elastomeric material. The guide structure 22 is disposed within a sleeve 24. Namely, in a preferred embodiment, the guide structure 22 directly abuts an inner wall of the sleeve 24 with its outer periphery. The sleeve 24, at least the inner wall and, at least in some embodiments, also the guide structure 22 have the same cross-sectional geometry all around and are in particular circular in shape. Preferably, the guide structure 22 is fastened to the inner wall of the sleeve 24 by material bonding, in particular, for example, by bonding the elastomeric material of the preferably tubular guide structure 22 to the material of the sleeve 24. The sleeve 24 is preferably made of a metal, in particular steel.

The two embodiments according to FIGS. 1,2 differ first of all in that the guide element 14 in the embodiment according to FIG. 1 is formed by an assembly unit formed of the sleeve 24 and the guide structure 22. This common assembly unit forming the guide element 14 is located in the hold-down 12. In the variants according to FIGS. 1,2, the guide element 14 extends over the entire length of the hold-down 12 (viewed in the axial direction 6). Similarly, the guide structure 22 also extends over the entire length of the sleeve 24 and thus also of the hold-down device 12.

For easy fastening of the assembly forming the guide element 14, the sleeve 24 according to FIG. 1 has a circumferential fastening collar 26 at its upper end. This is preferably arranged, specifically clamped, between the hold-down device 12 and an underside of the feed unit 10. The hold-down device 12 and/or the underside of the feed unit 10 have, for example, a recess for positive reception of the fastening collar 26.

In contrast to the embodiment according to FIG. 1, in FIG. 2 the guide structure 22 is attached directly to an inner wall of the hold-down 12. In this case, therefore, the hold-down device 12 also forms the sleeve 24.

In both cases, therefore, a sleeve 24 is provided which surrounds the guide structure 22 circumferentially. The sleeve 24 has a high rigidity and strength in each case, so that it is not elastically yielding compared to the elastic guide structure 22.

When the component M is pressed through the guide structure 22, this results in only the material of the guide structure 22 being elastically compressed at a respective current position of the nut M. Immediately after the component M has been pushed through, the material relaxes again and the guide structure 22 resumes its original geometry. Accordingly, the guide structure 22 has an inner dimension, in particular an inner diameter d1, which is slightly smaller than an outer diameter or a maximum outer dimension d4 of the component M. The guide structure 22 further has an outer dimension, in particular an outer diameter d2. The punch 8, in turn, is guided as accurately as possible within the guide structure 22, thus preferably having an outer diameter which is matched to the inner diameter d1 of the guide structure 22. Preferably, the punch 8 has a (circular) punch surface corresponding to the component M, in particular an outer diameter d4.

In the embodiments according to FIGS. 1 and 2, it is provided that the guide structure 22 has an insertion chamfer or a conical widening at its upper end. This is formed, for example, by a conical material removal on the inside of the guide structure 22, as indicated in FIG. 1. Alternatively, the guide structure 22 is widened conically overall at its upper end, as is shown in FIG. 2. In this case, the sleeve 24 also has a corresponding conical widening.

The guide structure 22 has an overall wall thickness w that is in the range of 2 to 10 mm and in particular in the range of 2 to 4 mm. The wall thickness w is constant over the entire length of the guide structure 22.

In the embodiment according to FIGS. 1 and 2, the guide structure 22 is a tube, i.e. a hollow cylindrical element, which is at most expanded in the upper region. In some embodiments, the tube has an inner contour that deviates from the circular shape, but preferably continues to be a hollow cylindrical element with a cylinder outer surface that abuts the sleeve 24.

In all embodiments described hereinbefore as well as hereinafter, the guide structure 22 is made of a highly elastic, abrasion-resistant material, specifically a polyurethane elastomer as previously described.

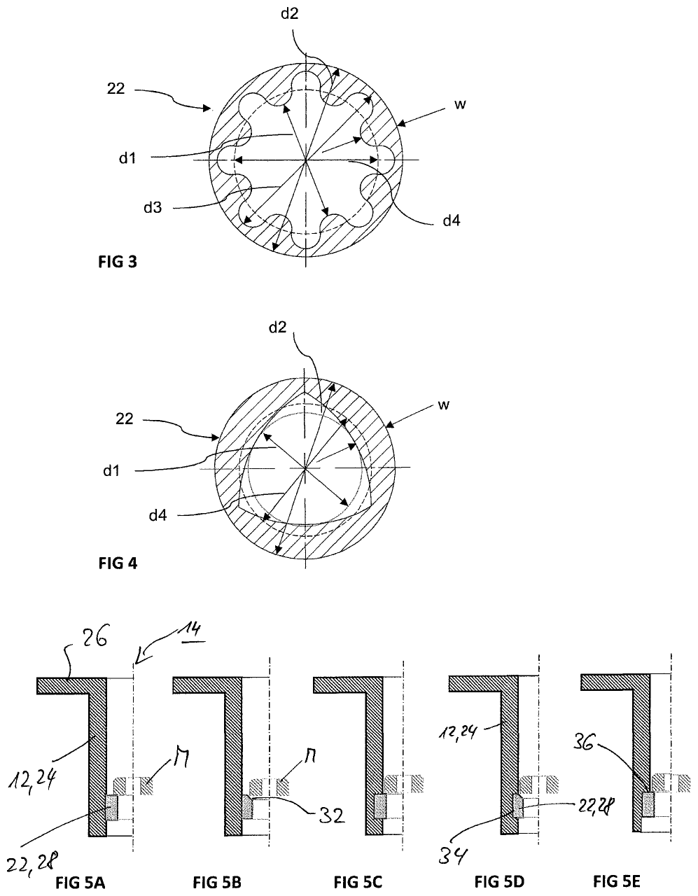

FIGS. 3 and 4 show two design variants for possible (cross-sectional) configurations of the guide structure 22 in the form of a tube. In each case, the tube has an inner contour that deviates from the circular shape.

As an alternative to the variants shown, the tube has a circular (cross-sectional) inner contour with the inner diameter d1 (inner dimension) and the outer diameter d2 (outer dimension) (cf. FIGS. 1, 2). In all variants, the tube preferably has a constant cross-sectional contour in the longitudinal direction 6. Alternatively, the tube—as shown for example in FIG. 2—is somewhat widened at the upper end and/or provided with an insertion chamfer.

The design with the non-circular inner contour, which deviates from the circular shape, generally ensures that the component M compresses the elastic tube 22 only in certain areas (viewed over the circumference). That is, the component M is only in contact with the elastic tube 22 in certain areas. Generally, the inner contour of the tube 22 deviates from an outer contour of the component M. The particular advantage is to be seen in the fact that material of the tube 22 can deviate in the circumferential direction. Overall, this measure allows the holding force applied by the guide element 14 to be adjusted in a desired manner.

In the variant shown in FIG. 3, the inner contour is wave-shaped.

In the embodiment according to FIG. 4, the inner contour is trilobular.

In all variants described above or below, the inner diameter d1 defines the inner dimension of the guide structure 22, which is smaller than an outer dimension of the component M. The outer dimension of the component M can be defined by a component outer circle with a component outer diameter d4, which is drawn as an example in FIGS. 3 and 4. This lies between the inner diameter d1 and the outer circle diameter d3, for example lying midway between the two diameters d1, d3. The guide structure 22 further has a (maximum) wall thickness w.

In the case of the unslotted tube shown in FIGS. 1 and 2 as the guide structure 22, the attachment of the tube to the sleeve 24 involves a certain amount of assembly work. And to reduce this, the various alternatives for the guide structure 22 described below are provided. The guide structure 22 is formed either in one or more parts. In particular, it has one or more strip- or strip-shaped elements and is formed by these in particular. The sleeve 24 used in the variants described below is preferably formed by the hold-down 12.

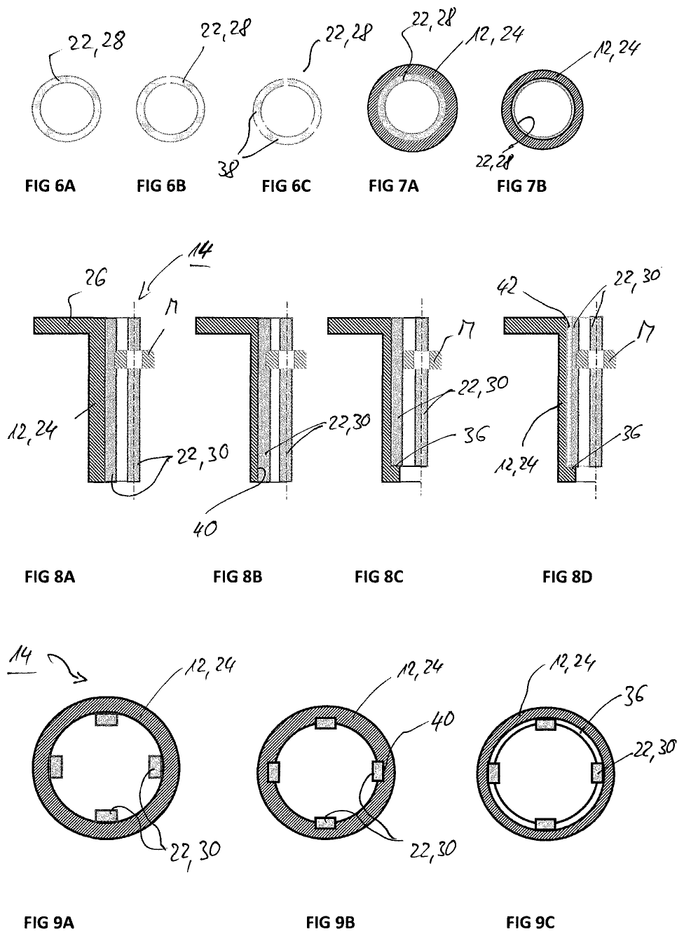

According to a first variant, the guide structure 22 is formed by an annular structure, hereinafter briefly referred to as ring 28. This variant is explained in more detail in particular in connection with FIGS. 5 and 6. In this respect, the ring 28 is a short tube, which therefore only extends over a short section in the axial direction 6.

According to a second basic variant, the guide structure 22 is formed by several guide strips 30 each extending in the axial direction 6. This embodiment variant is explained in more detail with reference to FIGS. 8-10.

FIGS. 5A to 5E each show half-sectional views of the sleeve 24 with the elastic guide structure 22 formed as a ring 28. The sleeve 24 is formed as a cylindrical sleeve with a radially projecting fastening collar 26. An insertion side is defined in the region of the fastening collar 26, and an exit side is defined at the opposite end of the sleeve, which is formed by a lower end of the sleeve 24. In each case, the ring 28 is disposed in the lower third of the sleeve 24. The ring 28 is spaced from the lower end, for example by at least half a ring width, viewed in axial direction 6. The maximum distance of the ring 28 from the lower end is one and at most two times the width of the ring 28 measured in axial direction 6.

In the embodiment according to FIG. 5A, the ring is applied to the cylindrical inner wall of the sleeve 24 and, in particular, bonded thereto. The same applies to the design variant according to FIG. 5B. In the latter, the ring 28 is bevelled at its upper end face and forms there an especially conical insertion chamfer 32, which facilitates the penetration of the component M.

This insertion chamfer reduces the axial load on the ring 28 when the component M is pressed through, compared to the variant shown in FIG. 5A.

The embodiments according to FIGS. 5C and 5D differ from the previously described variants in that the sleeve has an annular groove 34 in which the ring 28 is inserted. The depth of the annular groove 34 in the radial direction is less than the corresponding depth of the material of the ring 28, so that the ring 28 thus protrudes in the radial direction into the interior of the sleeve 24. An inner diameter of the sleeve 24 is adapted to the outer diameter of the component M, so that the latter is already somewhat guided over the entire length of the sleeve 24 and the risk of tilting, for example, is reduced.

Due to the smaller inner diameter of the sleeve 14, which preferably also forms the hold-down device 12, compared to the variants described above, the overall inner diameter of the hold-down device 12 is also smaller, which is advantageous for the entire pressing process.

The particular advantage of this embodiment with the annular groove 34 is to be seen in the form-fit retention of the ring 28 and also in the fact that the ring 28 projects radially into the sleeve 24. Both measures result in the forces acting on the ring 28 when the component M is pressed through being low or being well absorbed by the form fit. The low load is further improved by the insertion chamfer 32 as shown in FIG. 5D. The variant shown in FIG. 5D forms a preferred variant for the design of the guide element 14 especially for the pressing of a nut.

Finally, in the embodiment according to FIG. 5E, instead of the annular groove 34, a recess is provided at the lower end of the sleeve 24 so that a shoulder 36 is formed. The ring 28 can therefore be pressed in and pushed against this shoulder 36 from below.

FIGS. 6A to 6C show different embodiments of the ring 28. Each of these variants can be combined with any of the variants shown in FIGS. 5A to 5E. In the embodiment variant according to FIG. 6A, the ring 28 is formed as a closed ring. In the embodiment according to FIG. 6B, the ring 28 is formed as an open ring, which thus has a (single) slot. In this embodiment, the ring 28 is therefore formed in the manner of a snap ring. This slotted or open design facilitates assembly. In the embodiment variant according to FIG. 6C, the ring 28 is formed by several ring segments, which are also referred to as tube segments 38. In the illustrated embodiment, a total of 3 ring segments are provided, each extending nearly over 120°. This segmented design also facilitates assembly.

The tube or hose shown in FIGS. 1 and 2, which extends over the entire length of the sleeve 24, is formed as a closed annular structure when viewed in cross-section, for example, as shown in FIG. 6A. Alternatively, the tube may also assume the embodiment according to FIGS. 6B or 6C, i.e. be formed as a single-slotted tube or also a multiple-slotted tube, or have multiple tube segments 38.

With reference to FIGS. 7A, 7B, which each show a view from below of the guide element 14, namely of the embodiments according to FIGS. 5A, 5B (FIG. 7A) and of the embodiments according to FIGS. 5C, 5D (FIG. 7B), it is readily apparent that in the latter embodiment, in which the ring 28 is located in the annular groove 34, the ring 28 and thus the elastomeric material protrudes only slightly into the interior of the sleeve 24.

FIGS. 8A to 8D show different embodiments in which the guide structure 22 is formed by a plurality of guide strips 30 extending in the axial direction 6. In this case, the guide strips 30 extend over the entire or at least almost the entire length (more than 75% of the length) of the sleeve 24. As can be seen from the views according to FIGS. 9A to 9C, only a few guide strips 30, for example 3-6 and in the illustrated embodiment four, are arranged distributed around the circumference of the sleeve 24.

In the embodiment according to FIGS. 8A and 9A, the individual guide strips 30 are applied to the cylindrical inner surface of the sleeve 24. In all embodiments of FIGS. 8A to 8D, the guide strips 30 are equally distributed around the circumference. They are formed as narrow guide strips 30, so that the distance in the circumferential direction between two adjacent guide strips 30 is significantly greater than the width of a respective guide strip 30 in the circumferential direction.

In the embodiment according to FIGS. 8B and 9B, grooves 40 are formed on the inner wall of the sleeve 24, which extend in the axial direction 6 and therefore form longitudinal grooves. The guide strips 30 lie in these grooves 40.

In the embodiment according to FIG. 8C, the sleeve 24 has a shoulder 36 at its lower end, which is designed in particular as a circumferential annular shoulder and on which a respective guide strip 30 is supported with its lower, front end in a form-fitting manner. This means that in the region of the shoulder 36, the wall thickness of the sleeve 26 is increased compared to the preceding cylindrical section. In the embodiment variant with grooves 40, shoulders 36 can also be provided in a respective groove 40.

The embodiment according to FIG. 8D shows an exemplary embodiment in which a mounting sleeve 42 is additionally provided. This is in particular a plastic sleeve with increased rigidity compared to the guide structure 22. Generally, the guide structure 22 is attached to this mounting sleeve 42 and forms a prefabricated assembly unit therewith. Particularly in the preferred embodiments, in which the sleeve 24 is formed by the hold-down device 12, a prefabricated structural unit is thereby provided as a replacement element. The mounting sleeve 42 is thereby preferably pressed into the sleeve 24. In principle, the mounting sleeve 42 can be combined with all embodiments described herein. The wall thickness of the mounting sleeve 42 is preferably less than that of the sleeve 24.

The embodiment shown in FIG. 8D builds on the embodiment shown in FIG. 8C with the shoulder 36. The prefabricated assembly with the mounting sleeve 42 and the guide strips 30 attached to the inside of the latter is therefore supported on the annular shoulder 36. The mounting sleeve 42 is preferably designed as a cylindrical sleeve in all embodiments.

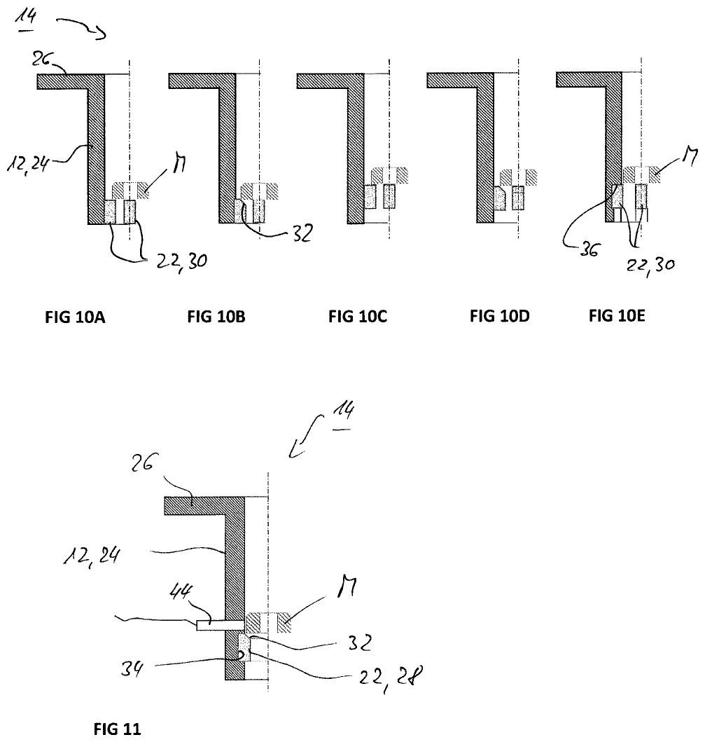

As an alternative to the embodiments according to FIGS. 8A to 8D with the guide strips 30 extending at least over almost the entire length of the sleeve 24, FIGS. 10A to 10E show embodiments with guide strips 30 extending only over a short axial length. Preferably, the guide strips 30 extend only over a maximum of ⅓ or a maximum of ¼ or even a maximum of 10% of the length of the sleeve 24.

In the embodiment according to FIGS. 10A, 10B, the guide strips 30 are attached to the lowermost end of the sleeve 24. In the embodiments according to FIGS. 10C, 10D, the guide strips 30 are attached at a distance from the bottom end. The distance is preferably less than the axial length of the guide strips 30.

Finally, in the embodiment according to FIG. 10E, a recess with a shoulder 36 is again provided, similar to the embodiment according to FIG. 5E.

The distribution of the guide strips 30 around the circumference is provided in the embodiments according to FIGS. 10A to 10E in the same manner as in the embodiments according to FIGS. 8A to 8D.

FIG. 11 shows an example of the additional arrangement of a sensor 44.

This is a position sensor which detects whether a component M is located in the guide element 14 and preferably also whether it is in the correct position. In the embodiment shown, the sensor 44 is arranged on the sleeve 12,24 and, in particular, is inserted into a receptacle or through-hole in the wall of the sleeve 24.

In the embodiment shown in FIG. 11, the ring 28 is used as the elastic guide structure 22, preferably in a circumferentially closed variant. Alternatively, the ring is slotted or divided into ring segments. The sensor 44 is arranged directly above the ring 28.

In the embodiments with the ring 28 in a lower region, the component M falls generally downward through the sleeve 12,24 toward the ring 28 and is caught and held by the ring 28, so to speak, before the actual setting process begins. During the actual setting process, the component M is then forced through the ring 28. The sensor 44 ensures that the component M is in the correct position and has not become stuck in the sleeve 12, 24 above the ring 28 due to jamming, for example.

In all variants, a further sensor is preferably arranged on the upper region of the sleeve 12, 24, specifically in the region of the pick-up position 16, which determines whether a component M is located in the pick-up position 16. In the embodiments with the ring 28, the sensor 44 is therefore preferably arranged on the sleeve 12, 24 in addition to this further sensor. Alternatively, the further sensor is dispensed with and only the sensor 44 is provided.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A processing tool for transferring a component from a pick-up position into a processing position, the processing tool comprising:
a punch that transfers the component from the pick-up position to the processing position;
a guide element in which the component is guided from the pick-up position to the processing position, the guide element is designed such that during operation it exerts an elastic holding force on the component in such a way that the punch presses the component through the guide element counter to the elastic holding force during operation,
wherein the guide element has a sleeve in which a guide structure made of an elastomer is arranged for guiding and holding the component

2. The processing tool according to claim 1, wherein the guide structure comprises a plurality of strip-shaped elements and wherein the plurality of strip-shaped elements extend in an axial direction in the manner of guide strips or at least one strip-shaped element extends annularly in a circumferential direction.

3. The processing tool according to claim 2, wherein the sleeve comprises a number of grooves in which the number of strip-shaped elements are arranged.

4. The processing tool of claim 1, wherein the guide structure is applied to a mounting sleeve that is sandwiched between the guide structure and the sleeve.

5. The processing tool according to claim 1, in which the sleeve has at least one shoulder at its end on which the guide strips are supported.

6. The processing tool according to claim 1, wherein the guide structure is formed as a tube, the guide structure being optionally slotted in the axial direction, having a plurality of tube segments, or being formed closed in a circumferential direction.

7. The processing tool according to claim 1, in which the guide structure is designed as a ring which extends in the axial direction only over a partial region of the sleeve, the ring being designed optionally as a closed ring, as a slotted ring or as a segmented ring.

8. The processing tool of claim 7, wherein the ring is disposed in a lower portion of the sleeve.

9. The processing tool of claim 7, wherein the ring is engaged in an annular groove.

10. The processing tool of claim 1, wherein a shoulder is formed against which the guide structure abuts.

11. The processing tool according to claim 1, wherein a sensor is arranged in the region of the sleeve, which sensor is designed to detect a component (M) located in the sleeve.

12. The processing tool according to claim 11, wherein the sensor is arranged in a wall of the sleeve.

13. The processing tool according to claim 1, wherein the guide structure is made of a cellular material.

14. The processing tool according to claim 1, wherein the guide structure is made of a polyurethane elastomer.

15. The processing tool according to claim 1, wherein the elastic holding force is exerted exclusively by compressing the guide structure.

16. The processing tool of claim 1, wherein the guide structure has a wall thickness that ranges from 2 mm to 10 mm.

17. The processing tool of claim 1, wherein the sleeve has an upper retaining collar at its end.

18. The processing tool of claim 1, wherein the guide structure directly engages a hold-down device and the hold-down device forms the sleeve.

19. The processing tool of claim 1, wherein the processing tool is a press tool for pressing a press-fit element such as a nut into a workpiece.

20. A guide element for a processing tool according to claim 1, comprising a sleeve in which a guide structure made of an elastomer is arranged.
